(19) United States
(12) Patent Application Publication
(10) Pub. No.: US 2023/0258779 A1
(43) Pub. Date: Aug. 17, 2023

(54) DISTANCE MEASUREMENT APPARATUS

(71) Applicant: Mitsubishi Electric Corporation, Tokyo (JP)

(72) Inventors: Natsuki HONDA, Chiyoda-ku, Tokyo (JP); Masayuki OMAKI, Chiyoda-ku, Tokyo (JP); Shota NAKAHARA, Chiyoda-ku, Tokyo (JP)

(73) Assignee: Mitsubishi Electric Corporation, Tokyo (JP)

(21) Appl. No.: 18/015,538

(22) PCT Filed: Aug. 31, 2020
(86) PCT No.: PCT/JP2020/032857

§ 371 Date: Jan. 11, 2023

(51) Int. Cl. G01S 7/481; G01S 17/10

(52) U.S. Cl. CPC G01S 7/4817; G01S 17/10; G01S 7/4812

(57) ABSTRACT

A distance measurement apparatus includes a light source, a scanning mirror, and a light receiving optical system. The light source emits a light beam. The scanning mirror scans the light beam. The light receiving optical system receives a return light. The light receiving optical system includes a focusing optical system, a light receiving element, and an aperture located between the focusing optical system and the light receiving element. The aperture is disposed on a focal plane of the focusing optical system. A viewing angle of the light receiving optical system is smaller than a divergence angle of the light beam.

### TECHNICAL FIELD

The present disclosure relates to a distance measurement apparatus.

### BACKGROUND ART

Japanese Patent No. 6519033 (PTL 1) discloses an object detection device including a light projecting portion, a scanning portion, and a light receiving portion. The light projecting portion includes a laser diode module and a light projecting optical system. The scanning portion includes a mirror and an actuator to drive the mirror. The light receiving portion includes a condenser lens, a light receiving element, and an aperture. A divergence angle α of a laser beam emitted from the laser diode module is equal to or less than an angle β. Angle β is given by arctan (D/d). D represents a diameter of the aperture, and d represents a distance from the condenser lens to the aperture.

### CITATION LIST

### Patent Literature

PTL 1: Japanese Patent No. 6519033

### SUMMARY OF INVENTION

### Technical Problem

In the object detection device of PTL 1, since angle β is equal to or larger than angle α, resolution of the object detection device is low. The present disclosure has been made in view of the above problem, and an object of the present disclosure is to provide a distance measurement apparatus having improved resolution.

### Solution to Problem

A distance measurement apparatus according to a first aspect of the present disclosure includes a first light source, a scanning mirror, and a first light receiving optical system. The first light source emits a first light beam. The scanning mirror scans the first light beam. The first light receiving optical system receives a first return light generated by the first light beam being reflected or scattered by at least one object. The first light receiving optical system includes a first focusing optical system, a first light receiving element, and a first aperture located between the first focusing optical system and the first light receiving element. The first aperture is disposed on a first focal plane of the first focusing optical system. A first viewing angle of the first light receiving optical system is smaller than a first divergence angle of the first light beam. The first viewing angle is given by arctan (D₁/F₁). f₁ represents a first focal distance of the first focusing optical system, and D₁ represents a first diameter of a first hole provided in the first aperture.

A distance measurement apparatus according to a second aspect of the present disclosure includes a plurality of light sources, a scanning mirror, a light scanning region correcting optical member, and a plurality of light receiving optical systems. The plurality of light sources respectively emit a plurality of light beams. The scanning mirror scans the plurality of light beams. The light scanning region correcting optical member corrects at least one of a plurality of light scanning regions formed by the plurality of light beams scanned by the scanning mirror. The plurality of light receiving optical systems respectively receive a plurality of return lights generated by the plurality of light beams being reflected or scattered by at least one object. Each of the plurality of light receiving optical systems includes a focusing optical system, a light receiving element, and an aperture located between the focusing optical system and the light receiving element. The aperture is disposed on a focal plane of the focusing optical system. A viewing angle of the light receiving optical system is smaller than a divergence angle of each of the plurality of light beams corresponding to the light receiving optical systems. The viewing angle of the light receiving optical system is given by arctan (D/f). f represents a focal distance of the focusing optical system. D represents a diameter of a hole provided in the aperture.

A direction in which a light scanning region is expanded by a first end portion of one of a pair of light scanning regions adjacent to each other among the plurality of light scanning regions overlapping only a second end portion of another one of the pair of light scanning regions or being in contact with the second end portion of the other one of the pair of light scanning regions is defined as a first axis. A normal line of the scanning mirror when the scanning mirror is at a center of a rotation range of the scanning mirror corresponding to the plurality of light scanning regions is defined as a second axis. As an angle between the second axis and an optical axis, which is projected on a plane including the first axis and the second axis, of each of the plurality of light beams to enter the scanning mirror is larger, the diameter of the hole provided in the aperture corresponding to each of the plurality of light beams is larger.

A distance measurement apparatus according to a third aspect of the present disclosure includes a plurality of light sources, a scanning mirror, a light scanning region correcting optical member, and a plurality of light receiving optical systems. The plurality of light sources respectively emit a plurality of light beams. The scanning mirror scans the plurality of light beams. The light scanning region correcting optical member corrects at least one of a plurality of light scanning regions formed by the plurality of light beams scanned by the scanning mirror. The plurality of light receiving optical systems respectively receive a plurality of return lights generated by the plurality of light beams being reflected or scattered by at least one object. Each of the plurality of light receiving optical systems includes a focusing optical system, a light receiving element, and an aperture located between the focusing optical system and the light receiving element. The aperture is disposed on a focal plane of the focusing optical system. A viewing angle of the light receiving optical system is smaller than a divergence angle of each of the plurality of light beams corresponding to the light receiving optical systems. The viewing angle of the light receiving optical system is given by arctan (D/f). f represents a focal distance of the focusing optical system. D represents a diameter of a hole provided in the aperture.

A direction in which a light scanning region is expanded by a first end portion of one of a pair of light scanning regions adjacent to each other among the plurality of light scanning regions overlapping only a second end portion of another one of the pair of light scanning regions or being in contact with the second end portion of the other one of the pair of light scanning regions is defined as a first axis. A normal line of the scanning mirror when the scanning mirror is at a center of a rotation range of the scanning mirror corresponding to the plurality of light scanning regions is defined as a second axis. As an angle between the second axis and an optical axis, which is projected on a plane including the first axis and the second axis, of each of the plurality of light beams to enter the scanning mirror is larger, the diameter of the hole provided in the aperture corresponding to each of the plurality of light beams is smaller.

### Advantageous Effects of Invention

In the distance measurement apparatus according to the first aspect of the present disclosure, the first aperture limits the angular range of the first return light that can enter the first light receiving element by making the first viewing angle of the first light receiving optical system smaller than the first divergence angle of the first light beam. Therefore, resolution of the distance measurement apparatus according to the first aspect of the present disclosure can be improved.

In each of the distance measurement apparatuses according to the second aspect and the third aspect of the present disclosure, the aperture limits the angular range of the return light that can enter each of the light receiving elements by making the viewing angle of each of the light receiving optical systems smaller than the divergence angle of each of the plurality of light beams corresponding to the light receiving optical systems. Therefore, resolution of the distance measurement apparatuses according to the second aspect and the third aspect of the present disclosure can be improved.

### BRIEF DESCRIPTION OF DRAWINGS

FIG. 1 is a schematic diagram of a distance measurement apparatus of each of first to third embodiments.

FIG. 2 is a schematic view of a light beam scanning apparatus included in the distance measurement apparatus of the first embodiment.

FIG. 3 is a schematic enlarged view of an irradiation optical system and a light source included in each of the distance measurement apparatuses of the first to third embodiments.

FIG. 4 is a schematic enlarged view of a first light receiving optical system included in each of the distance measurement apparatuses of the first to third embodiments.

FIG. 5 is a schematic enlarged view of a first light receiving optical system included in a distance measurement apparatus of a first modification of the first embodiment.

FIG. 6 is a schematic view of a light beam scanning apparatus included in a distance measurement apparatus of a second modification of the first embodiment.

FIG. 7 is a schematic view of a light beam scanning apparatus included in the distance measurement apparatus of the second embodiment.

FIG. 8 is a schematic enlarged view of a first light receiving optical system included in the distance measurement apparatus of the second embodiment.

FIG. 9 is a schematic plan view of a light beam scanning apparatus included in the distance measurement apparatus of the third embodiment.

FIG. 10 is a schematic front view of the light beam scanning apparatus included in the distance measurement apparatus of the third embodiment.

FIG. 11 is a schematic enlarged view of a second light receiving optical system included in the distance measurement apparatus of the third embodiment.

FIG. 12 is a view illustrating definitions of θₓₐ and θ_{ya}.

FIG. 13 is a view illustrating a plurality of light scanning regions of a distance measurement apparatus of a comparative example.

FIG. 14 is a view illustrating a plurality of light scanning regions of the distance measurement apparatus of the third embodiment.

### DESCRIPTION OF EMBODIMENTS

Hereinafter, embodiments of the present disclosure will be described. Note that the same components are denoted by the same reference numerals, and description thereof will not be repeated.

### First Embodiment

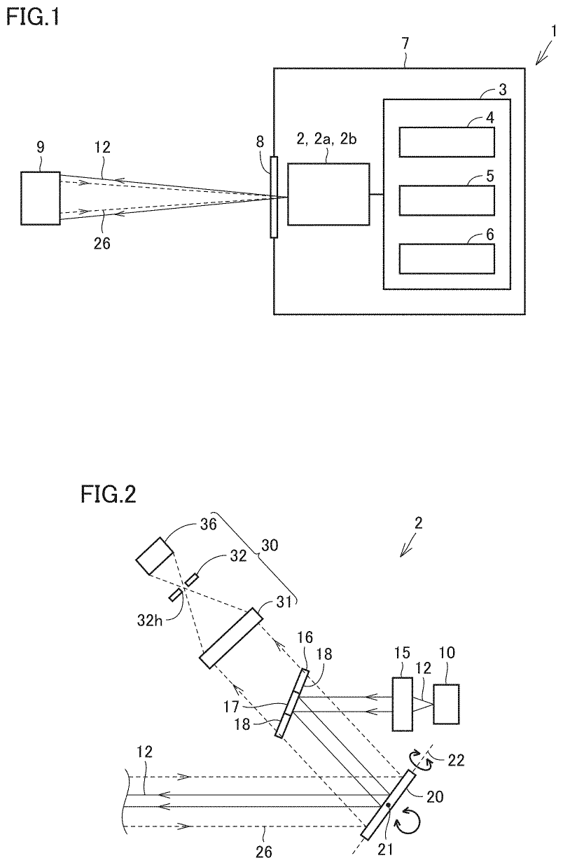

Referring to FIGS. 1 to 4, a distance measurement apparatus 1 according to a first embodiment will be described. Distance measurement apparatus 1 includes a light beam scanning apparatus 2, a computer 3, and a housing 7. Light beam scanning apparatus 2 includes a light source 10, an irradiation optical system 15, an optical beam splitter 16, a scanning mirror 20, and a light receiving optical system 30.

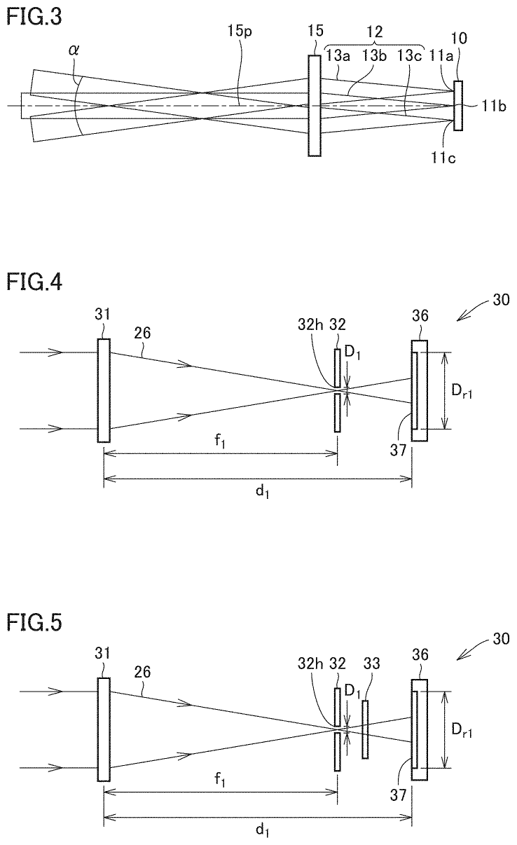

Referring to FIGS. 2 and 3, light source 10 emits a light beam 12. For example, light source 10 is a semiconductor laser, and light beam 12 is a laser beam. For example, as illustrated in FIG. 3, light source 10 includes a plurality of light emission points 11a, 11b, 11c. Light source 10 has, for example, a high output of 10 W or more.

The plurality of light emission points 11a, 11b, 11c are arranged in one direction such as a horizontal direction, for example. Light source 10 has such a wide light emitting region width that it cannot be regarded as a point light source in a direction in which the plurality of light emission points 11a, 11b, 11c are arranged. The plurality of light emission points 11a, 11 b, 11c emit a plurality of light beams 13a, 13b, 13c, respectively. Light beam 12 includes the plurality of light beams 13a, 13b, 13c. Optical axes of the plurality of light beams 13a, 13b, 13c are parallel to one another. The optical axes of the plurality of light beams 13a, 13b, 13c are, for example, parallel to an optical axis 15p of irradiation optical system 15. Each of the plurality of light beams 13a, 13b, 13c has a spread angle.

Irradiation optical system 15 collimates light beam 12 emitted from light source 10. Irradiation optical system 15 includes, for example, a convex lens. The plurality of light emission points 11a, 11b, 11c are located on a focal plane of irradiation optical system 15. As described above, light source 10 has such a wide light emitting region width that it cannot be regarded as a point light source in the direction in which the plurality of light emission points 11a, 11b, 11c are arranged. Therefore, as illustrated in FIG. 3, light beam 12 having passed through irradiation optical system 15 has a divergence angle α in the direction in which the plurality of light emission points 11a, 11b, 11c are arranged.

Specifically, one light emission point 11b of the plurality of light emission points 11a, 11b, 11c is located on optical axis 15p of irradiation optical system 15 (that is, at a focal point of irradiation optical system 15). Therefore, light beam 13b emitted from light emission point 11b is collimated by irradiation optical system 15 and advances in parallel to optical axis 15p of irradiation optical system 15. On the other hand, light emission points 11a, 11c are shifted from optical axis 15p (that is, the focal point of irradiation optical system 15) of irradiation optical system 15 in the direction in which the plurality of light emission points 11a, 11b, 11c are arranged. Therefore, light beam 13a emitted from light emission point 11a is collimated by irradiation optical system 15 and advances obliquely to optical axis 15p of irradiation optical system 15. Light beam 13c emitted from light emission point 11c is collimated by irradiation optical system 15 and advances obliquely to optical axis 15p of irradiation optical system 15. Thus, light beam 12 having passed through irradiation optical system 15 has divergence angle α.

Referring to FIG. 2, optical beam splitter 16 splits light beam 12 and a return light 26 generated by light beam 12 being reflected or scattered by at least one object 9 (see FIG. 1). For example, optical beam splitter 16 reflects light beam 12 and transmits return light 26. Specifically, optical beam splitter 16 includes a reflective portion 17 and a transmissive portion 18. Reflective portion 17 reflects, toward scanning mirror 20, light beam 12 having passed through irradiation optical system 15. Transmissive portion 18 transmits return light 26 toward light receiving optical system 30. Optical beam splitter 16 is obtained, for example, by selectively forming a reflection film on a portion of a transparent plate corresponding to reflective portion 17.

Scanning mirror 20 reflects and scans light beam 12. Scanning mirror 20 can rotate about two rotation axes 21, 22 that are parallel to a plane perpendicular to a normal line of scanning mirror 20 and are perpendicular to each other. Scanning mirror 20 two-dimensionally scans light beam 12. Scanning mirror 20 is, for example, a microelectromechanical systems (MEMS) mirror. Light beam 12 scanned by scanning mirror 20 irradiates a light scanning region.

Referring to FIGS. 2 and 4, light receiving optical system 30 receives return light 26. Light receiving optical system 30 includes a focusing optical system 31, an aperture 32, and a light receiving element 36.

Focusing optical system 31 guides return light 26 to light receiving element 36 while focusing return light 26. Focusing optical system 31 includes, for example, a condenser lens. Focusing optical system 31 has a first focal distance f₁.

Light receiving element 36 receives return light 26. Light receiving element 36 is, for example, a photodiode such as an avalanche photodiode or a single photon avalanche photodiode, or a silicon photomultiplier (SiPM). By using light receiving element 36 having high sensitivity such as an avalanche photodiode, a single photon avalanche photodiode, or a silicon photomultiplier, weak return light 26 from at least one object 9 that is far from distance measurement apparatus 1 and has a low reflectance can be detected. Therefore, a distance that can be measured by distance measurement apparatus 1 increases, and distance measurement apparatus 1 can obtain an accurate distance image of at least one object 9 over a wider range.

Referring to FIG. 4, light receiving element 36 includes a light receiving region 37. Light receiving region 37 is a region having sensitivity to return light 26 in light receiving element 36. Return light 26 enters light receiving region 37. Light receiving region 37 has a diameter Dᵣ₁ in the direction corresponding to divergence angle α. Light receiving region 37 of light receiving element 36 is separated from focusing optical system 31 by a distance d₁ in an optical axis direction of return light 26.

Aperture 32 is disposed between focusing optical system 31 and light receiving element 36. Aperture 32 is disposed on a focal plane of focusing optical system 31. Aperture 32 is provided with a hole 32h. Aperture 32 limits an angular range of return light 26 that can enter light receiving element 36. Since light receiving optical system includes aperture 32, a first viewing angle θ₁ of light receiving optical system 30 is given by arctan (D₁/F₁). D₁ is a diameter of hole 32h in the direction corresponding to divergence angle α. First viewing angle θ₁ of light receiving optical system 30 is smaller than divergence angle a of light beam 12. On the other hand, a viewing angle θᵣ₁ of light receiving optical system 30 without aperture 32 is given by arctan (Dᵣ₁/d₁). Viewing angle θ₁ of light receiving optical system 30 without aperture 32 is larger than divergence angle α of light beam 12.

Referring to FIG. 1, computer 3 includes a controller 4, a calculator 5, and a storage device 6 such as a ROM or a hard disk. Controller 4 and calculator 5 are, for example, processors such as a central processing unit (CPU), a graphics processing unit (GPU), or a field-programmable gate array (FPGA) included in computer 3.

Controller 4 is communicably connected to light source 10, scanning mirror 20, and light receiving element 36. Controller 4 controls distance measurement apparatus 1.

Specifically, controller 4 controls light source 10 to control timing when pulsed light beam 12 is emitted from light source 10. Controller 4 receives first timing when light source 10 emits light beam 12 from light source 10. Controller 4 controls scanning mirror 20. Controller 4 receives a tilting angle (for example, an angle of the normal line of scanning mirror 20) of scanning mirror 20. Controller 4 receives, from light receiving element 36, a signal corresponding to a light amount of return light 26 received by light receiving element 36. Controller 4 receives second timing when light receiving element 36 receives return light 26.

Calculator 5 calculates an emission direction of light beam 12 from the tilting angle of scanning mirror 20 received by controller 4 and a position of light source 10 with respect to scanning mirror 20 stored in storage device 6. Calculator 5 receives, from controller 4, the first timing when light source 10 emits light beam 12. Calculator 5 receives, from controller 4, the second timing when light receiving element 36 receives return light 26. Calculator 5 calculates a distance from distance measurement apparatus 1 to at least one object 9 and a direction of at least one object 9 with respect to distance measurement apparatus 1 on the basis of the emission direction of light beam 12, the first timing when light source 10 emits light beam 12, and the second timing when light receiving element 36 receives return light 26.

Calculator 5 generates a distance image of at least one object 9 including the distance from distance measurement apparatus 1 to at least one object 9 and the direction of at least one object 9 with respect to distance measurement apparatus 1. Calculator 5 outputs the distance image of at least one object 9 to storage device 6 or a display device (not illustrated) communicably connected to computer 3. The display device displays the distance image of at least one object 9.

Housing 7 houses light beam scanning apparatus 2, and computer 3. Housing 7 is provided with a transparent window 8 that transmits light beam 12 and return light 26. Transparent window 8 may be formed of a wavelength filter that transmits light beam 12 and return light 26, but has a different wavelength from light beam 12 and return light 26 to block unwanted light. Computer 3 may be disposed outside housing 7.

Referring to FIG. 5, in a first modification of the present embodiment, light receiving optical system 30 further includes an optical diffusion element 33. Optical diffusion element 33 is disposed between aperture 32 and light receiving element 36. Optical diffusion element 33 is, for example, an optical diffusion plate or an optical diffusion film.

When return light 26 passes through hole 32h of aperture 32, a part of return light 26 is diffracted, and light intensity distribution of return light 26 becomes non-uniform. In the present specification, the light intensity distribution of return light 26 means light intensity distribution of return light 26 in a plane perpendicular to the optical axis of return light 26. As the light intensity distribution of return light 26 becomes more uniform, sensitivity of light receiving element 36 is improved. Optical diffusion element 33 diffuses return light 26 having passed through hole 32h of aperture 32 to make the light intensity distribution of return light 26 more uniform.

Therefore, the sensitivity of light receiving element 36 to return light 26 is improved. In order to make the light intensity distribution of the return light 26 more uniform, a diffractive optical element (DOE) such as a diffraction grating may be used instead of optical diffusion element 33.

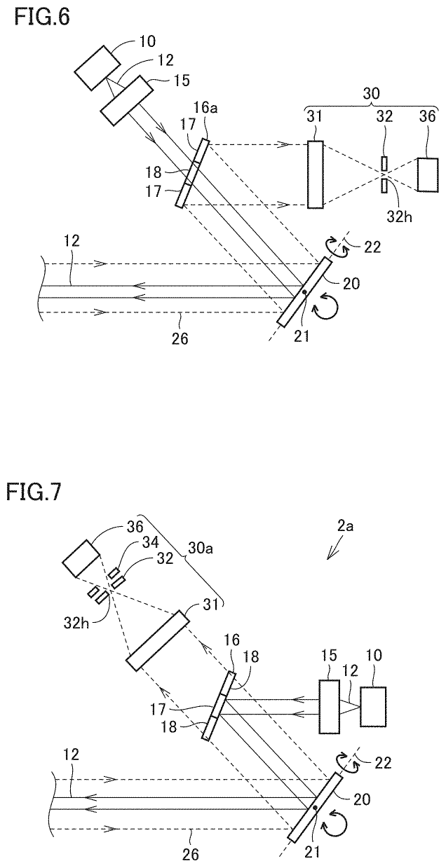

Referring to FIG. 6, in a second modification of the present embodiment, transmissive portion 18 of optical beam splitter 16 transmits, toward scanning mirror 20, light beam 12 emitted from light source 10. Reflective portion 17 of optical beam splitter 16 reflects return light 26 toward light receiving optical system 30. Optical beam splitter 16 may be, for example, a perforated mirror. The perforated mirror is a reflection mirror in which a hole is provided in a portion corresponding to transmissive portion 18.

In a third modification of the present embodiment, light source 10 may be a multi-mode laser. Output of the multi-mode laser is greater than output of a single-mode laser. The multi-mode laser is, for example, a horizontal multi-mode laser that performs multi-mode oscillation in the horizontal direction and performs single-mode oscillation in a vertical direction. The multi-mode laser has such a wide light emitting region width that it cannot be regarded as a point light source in the direction of the multimode oscillation. Therefore, light beam 12 having passed through irradiation optical system 15 has divergence angle α.

Effects of distance measurement apparatus 1 of the present embodiment will be described.

Distance measurement apparatus 1 of the present embodiment includes a first light source (light source 10), scanning mirror 20, and a first light receiving optical system (light receiving optical system 30). The first light source emits a first light beam (light beam 12). Scanning mirror 20 scans the first light beam. The first light receiving optical system receives a first return light (return light 26) generated by the first light beam being reflected or scattered by at least one object 9. The first light receiving optical system includes a first focusing optical system (focusing optical system 31), a first light receiving element (light receiving element 36), and a first aperture (aperture 32) located between the first focusing optical system and the first light receiving element. The first aperture is disposed on a first focal plane of the first focusing optical system. First viewing angle θ₁ of the first light receiving optical system is smaller than a first divergence angle (divergence angle α) of the first light beam. The first viewing angle θ₁ is given by arctan (DA). f₁ represents the first focal distance of the first focusing optical system, and D₁ represents a first diameter of a first hole (hole 32h) provided in the first aperture.

The first aperture (aperture 32) makes first viewing angle θ₁ of the first light receiving optical system (light receiving optical system 30) smaller than the first divergence angle (divergence angle α) of the first light beam (light beam 12) and limits an angular range of the first return light (return light 26) that can enter the first light receiving element (light receiving element 36). Therefore, resolution of distance measurement apparatus 1 can be improved.

In addition, since the first light receiving optical system (light receiving optical system 30) of distance measurement apparatus 1 includes the first aperture (aperture 32), it is not necessary to lengthen irradiation optical system 15 in order to improve the resolution of the distance measurement apparatus 1. A low cost and compact distance measurement apparatus 1 can be provided.

In distance measurement apparatus 1 of the present embodiment, viewing angle θᵣ₁ of the first light receiving optical system (light receiving optical system 30) without the first aperture (aperture 32) is larger than the first divergence angle (divergence angle α) of the first light beam (light beam 12). Viewing angle θᵣ₁ of the first light receiving optical system without the first aperture (aperture 32) is given by arctan (Dᵣ₁/d₁). d₁ represents a distance between the first focusing optical system and light receiving region 37 of the first light receiving element (light receiving element 36), and Dᵣ₁ represents the diameter of light receiving region 37.

Generally, as the output of the light source increases, the divergence angle of the light beam emitted from the light source increases. However, the first aperture (aperture 32) makes first viewing angle θ₁ of the first light receiving optical system (light receiving optical system 30) smaller than the first divergence angle (divergence angle α) of the first light beam (light beam 12) and limits the angular range of the first return light (return light 26) that can enter the first light receiving element (light receiving element 36). Therefore, even if a high-output light source is used as the first light source (light source 10), the resolution of distance measurement apparatus 1 can be improved. In addition, since a high-output light source can be used as the first light source (light source 10), the distance that can be measured by distance measurement apparatus 1 increases, and distance measurement apparatus 1 can obtain an accurate distance image of at least one object 9 over a wider range.

In distance measurement apparatus 1 of the present embodiment, the first light source is a laser in which a plurality of light emission points are arranged, or a multi-mode laser.

Therefore, a low-cost and high-output laser light source can be used as the first light source. Generally, as the output of the light source increases, the divergence angle of the light beam emitted from the light source increases. However, the first aperture (aperture 32) makes first viewing angle θ₁ of the first light receiving optical system (light receiving optical system 30) smaller than the first divergence angle (divergence angle α) of the first light beam (light beam 12) and limits the angular range of the first return light (return light 26) that can enter the first light receiving element (light receiving element 36). Therefore, even if a low cost and high-output light source is used as the first light source (light source 10), the resolution of distance measurement apparatus 1 can be improved. In addition, since a high-output light source can be used as the first light source (light source 10), the distance that can be measured by distance measurement apparatus 1 increases, and distance measurement apparatus 1 can obtain an accurate distance image of at least one object 9 over a wider range.

In distance measurement apparatus 1 of the present embodiment, the first light receiving optical system (light receiving optical system 30) further includes optical diffusion element 33 or the diffractive optical element disposed between the first aperture (aperture 32) and the first light receiving element (light receiving element 36).

Optical diffusion element 33 or the diffractive optical element makes the light intensity distribution of return light 26 passing through the first hole (hole 32h) of the first aperture (aperture 32) more uniform. Therefore, the sensitivity of the first light receiving element (light receiving element 36) is improved. The distance that can be measured by distance measurement apparatus 1 increases, and distance measurement apparatus 1 can obtain an accurate distance image of at least one object 9 over a wider range.

### Second Embodiment

Referring to FIGS. 1, 3, 7, and 8, distance measurement apparatus 1 according to a second embodiment will be described. Distance measurement apparatus 1 of the present embodiment has a configuration similar to that of distance measurement apparatus 1 of the first embodiment, but is different from distance measurement apparatus 1 of the first embodiment in that a light beam scanning apparatus 2a is provided instead of light beam scanning apparatus 2.

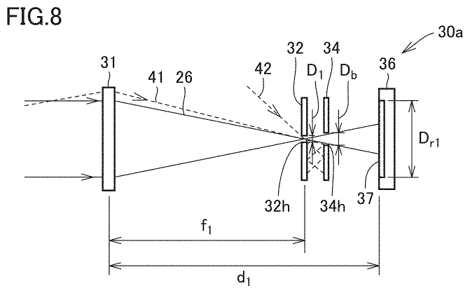

Referring to FIGS. 7 and 8, light beam scanning apparatus 2a has a configuration similar to that of light beam scanning apparatus 2 of the first embodiment, but is different from light beam scanning apparatus 2 of the first embodiment in that a light receiving optical system 30a is included instead of light receiving optical system 30. Light receiving optical system 30a further includes a rear aperture 34. Rear aperture 34 is disposed between aperture 32 and light receiving element 36. A diameter D_{b} of a hole 34h of rear aperture 34 is larger than diameter D₁ of hole 32h of aperture 32. Therefore, return light 26 passing through hole 32h of aperture 32 is prevented from being vignetted by rear aperture 34.

Rear aperture 34 prevents stray lights 41, 42 from entering light receiving element 36. Specifically, in addition to return light 26 from at least one object 9, ambient light enters light receiving optical system 30a as stray light 41 from an outside of distance measurement apparatus 1. Furthermore, inside distance measurement apparatus 1, a part of light beam 12 is reflected or scattered on a surface of an optical component (for example, a lens) included in irradiation optical system 15, a surface of optical beam splitter 16, or the like, so that stray light 42 is generated. Rear aperture 34 prevents stray light 41 from the outside of distance measurement apparatus 1 and stray light 42 inside distance measurement apparatus 1 from entering light receiving element 36.

In one example, rear aperture 34 is disposed relative to aperture 32 so that stray lights 41, 42 are multiply reflected between aperture 32 and rear aperture 34. A surface of rear aperture 34 has a low reflectance. Therefore, stray lights 41, 42 are multiply reflected and attenuated between aperture 32 and rear aperture 34. In another example, rear aperture 34 may be a light absorbing member. Stray lights 41, 42 are absorbed and attenuated by rear aperture 34.

Distance measurement apparatus 1 of the present embodiment has the following effects in addition to the effects of distance measurement apparatus 1 of the first embodiment.

In distance measurement apparatus 1 of the present embodiment, the first light receiving optical system (light receiving optical system 30a) further includes rear aperture 34 disposed between the first aperture (aperture 32) and the first light receiving element (light receiving element 36). Diameter D_{b} of hole 34h of rear aperture 34 is larger than the first diameter (diameter D₁) of the first hole (hole 32h) of the first aperture.

Therefore, rear aperture 34 can prevent stray light 41 from the outside of distance measurement apparatus 1 and stray light 42 inside distance measurement apparatus 1 from entering the first light receiving element (light receiving element 36). Weak return light 26 from at least one object 9 that is far from distance measurement apparatus 1 and has a low reflectance can be accurately detected. The distance that can be measured by distance measurement apparatus 1 increases, and distance measurement apparatus 1 can obtain an accurate distance image of at least one object 9 over a wider range.

### Third Embodiment

Referring to FIGS. 1, 3, 4, and 9 to 11, distance measurement apparatus 1 according to a third embodiment will be described. Distance measurement apparatus 1 of the present embodiment has a configuration similar to distance measurement apparatus 1 of the first embodiment, but is different from distance measurement apparatus 1 of the first embodiment mainly in the following points.

Distance measurement apparatus 1 of the present embodiment includes a light beam scanning apparatus 2b instead of light beam scanning apparatus 2 (see FIG. 2). Light beam scanning apparatus 2b further includes a light source 10b, an irradiation optical system 15b, an optical beam splitter 16b, and a light receiving optical system 30b in addition to the configuration of light beam scanning apparatus 2. Distance measurement apparatus 1 of the present embodiment further includes a light scanning region correcting optical member 50.

Light source 10b emits a light beam 12b. For example, light source 10b is a semiconductor laser, and light beam 12b is a laser beam. Light source 10b includes a configuration similar to that of light source 10 illustrated in FIG. 3. In one example, light source 10b includes a plurality of light emission points. In another example, light source 10b is a multi-mode laser such as a high-out horizontal multi-mode laser source. Light source 10b has such a wide light emitting region width that it cannot be regarded as a point light source. Optical axes of the plurality of light sources 10, 10b are nonparallel to one another.

Irradiation optical system 15b has a function similar to that of irradiation optical system 15. Specifically, irradiation optical system 15b collimates light beam 12b emitted from light source 10b. As described above, light source 10b has such a wide light emitting region width that it cannot be regarded as a point light source. Therefore, light beam 12b having passed through irradiation optical system 15b has a second divergence angle similarly to light beam 12 having passed through irradiation optical system 15.

Optical beam splitter 16b has a function similar to that of optical beam splitter 16. Optical beam splitter 16b splits light beam 12b and a return light 26b generated by light beam 12b being reflected or scattered by at least one object 9 (see FIG. 1). For example, optical beam splitter 16b reflects light beam 12b toward scanning mirror 20. Optical beam splitter 16b transmits return light 26b. Optical beam splitter 16b be configured similarly to optical beam splitter 16.

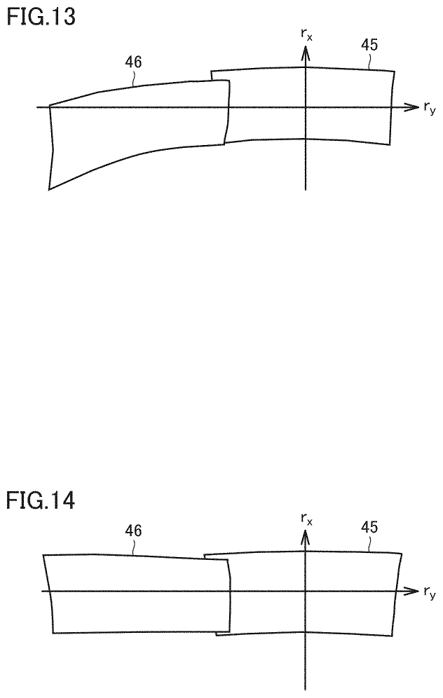

Scanning mirror 20 further reflects and scans light beam 12b. Scanning mirror 20 further two-dimensionally scans light beam 12b. Light beam 12 scanned by scanning mirror 20 irradiates a light scanning region 45 (see FIG. 14). Light beam 12b scanned by scanning mirror 20 irradiates a light scanning region 46 (see FIG. 14).

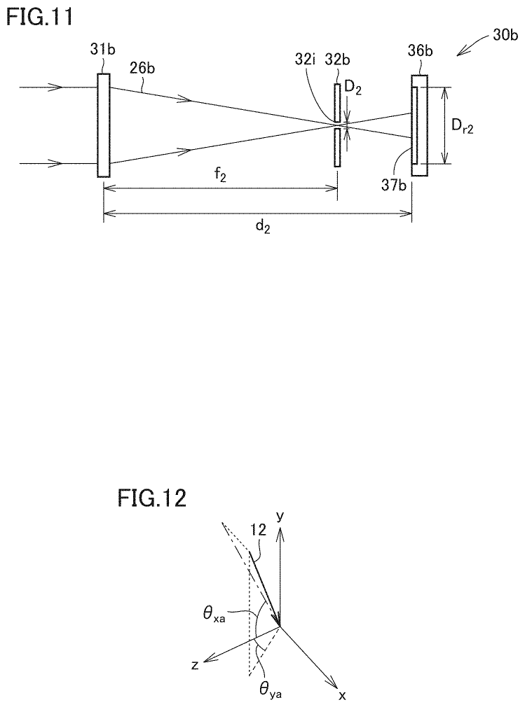

Referring to FIGS. 10 and 11, light receiving optical system 30b receives return light 26b. Light receiving optical system 30b includes a focusing optical system 31b, an aperture 32b, and a light receiving element 36b.

Focusing optical system 31b has a function similar to that of focusing optical system 31. Specifically, focusing optical system 31b guides return light 26b to light receiving element 36b while focusing return light 26b. Focusing optical system 31b includes, for example, a condenser lens. Focusing optical system 31b has a second focal distance f₂.

Light receiving element 36b receives return light 26b. Light receiving element 36b is, for example, a photodiode such as an avalanche photodiode or a single photon avalanche photodiode, or a silicon photomultiplier (SiPM). By using light receiving element 36b having high sensitivity such as an avalanche photodiode, a single photon avalanche photodiode, or a silicon photomultiplier, weak return light 26b from at least one object 9 that is far from distance measurement apparatus 1 and has a low reflectance can be detected. Therefore, a distance that can be measured by distance measurement apparatus 1 increases, and distance measurement apparatus 1 can obtain an accurate distance image of at least one object 9 over a wider range.

Referring to FIG. 11, light receiving element 36b includes a light receiving region 37b. Light receiving region 37b is a region having sensitivity to return light 26b in light receiving element 36b. Return light 26b enters light receiving region 37b. Light receiving region 37b has a diameter Dᵣ₂ in a direction corresponding to the second divergence angle. Light receiving region 37b of light receiving element 36b is separated from focusing optical system 31 by a distance d₂ in an optical axis direction of return light 26.

Aperture 32b is disposed between focusing optical system 31b and light receiving element 36b. Aperture 32b is disposed on a second focal plane of focusing optical system 31b. Aperture 32b is provided with a hole 32i. Aperture 32b limits an angular range of return light 26b that can enter light receiving element 36b. Since light receiving optical system 30b includes aperture 32b, a second viewing angle θ₂ of light receiving optical system 30b is given by arctan (D₂/f₂). D₂ is a diameter of hole 32i in a direction corresponding to the second divergence angle. Second viewing angle θ₂ of light receiving optical system 30b is smaller than the second divergence angle of light beam 12b. On the other hand, a viewing angle θᵣ₂ of light receiving optical system 30b without aperture 32b is given by arctan (Dᵣ₂/d₂). Viewing angleθᵣ₂ of light receiving optical system 30b without aperture 32b is larger than the second divergence angle of light beam 12b.

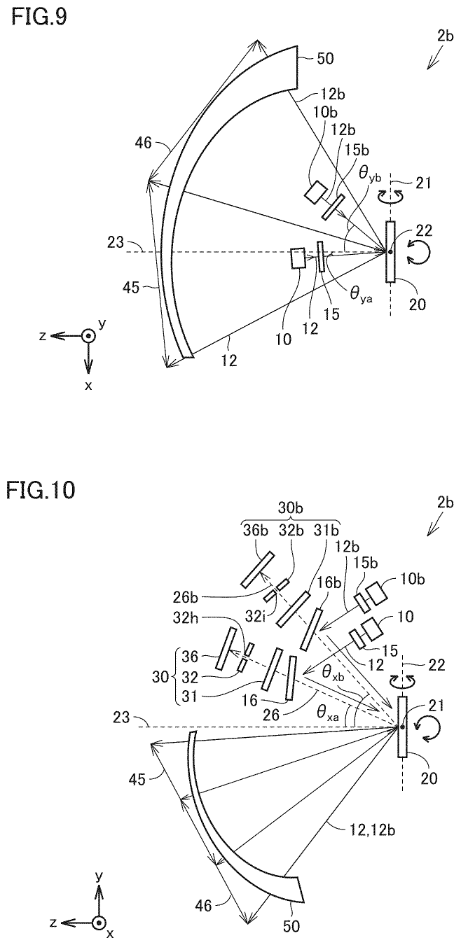

Referring to FIGS. 9 and 14, the plurality of light scanning regions 45, 46 are arranged in a first direction (x axis). Distance measurement apparatus 1 (light beam scanning apparatus 2b) can expand the light scanning region in the first direction (x axis). rₓ (see FIGS. 13 and 14) represents a rotation angle of scanning mirror 20 around rotation axis 21 (x axis). r_{y} (see FIGS. 13 and 14) represents a rotation angle of scanning mirror 20 around rotation axis 22 (y axis).

In the direction (first direction (x axis)) in which the plurality of light scanning regions 45, 46 are arranged, an end portion of one of a pair of light scanning regions adjacent to each other overlaps only an end portion of another one of the pair of light scanning regions adjacent to each other, or is in contact with the end portion of the other one of the pair of light scanning regions adjacent to each other. In the direction (first direction (x axis)) in which the plurality of light scanning regions 45, 46 are arranged, a central region of the one of the pair of light scanning regions adjacent to each other does not overlap at a central portion of the other of the pair of light scanning regions adjacent to each other. The central region of the one of the pair of adjacent light scanning regions adjacent to each other is shifted from the central portion of the other one of the pair of the light scanning regions adjacent to each other in the direction in which the plurality of light scanning regions 45, 46 are arranged (first direction (x axis)).

Specifically, in the direction in which the plurality of light scanning regions 45, 46 are arranged (first direction (x-axis direction)), an end portion of the light scanning region 46 overlaps only an end portion of the light scanning region 45 or is in contact with the end portion of the light scanning region 45. In the direction in which the plurality of light scanning regions 45, 46 are arranged (first direction (x-axis direction)), a central portion of light scanning region 46 does not overlap a central portion of light scanning region 45. The central portion of the light scanning region 46 is shifted from the central portion of the light scanning region 45 in the direction (first direction (x-axis direction)) in which the plurality of light scanning regions 45, 46 are arranged.

In the present specification, the direction (first direction) in which the light scanning region of distance measurement apparatus 1 is expanded by the end portion of light scanning region 45 overlapping only the end portion of light scanning region 46 or being in contact with the end portion of light scanning region 46 is defined as the x axis. A normal line 23 of scanning mirror 20 when scanning mirror 20 is at a center of a rotation range of scanning mirror 20 corresponding to the plurality of light scanning regions 45, 46 is defined as a z axis. A center of the rotation range of scanning mirror 20 corresponding to light scanning region 45 and a center of the rotation range of scanning mirror 20 corresponding to light scanning region 46 are the same. The y axis is perpendicular to the x axis and the z axis. A plane including the x axis and the z axis is defined as a first plane (zx plane). A plane including the z axis and the y axis is defined as a second plane (yz plane).

A reason why distance measurement apparatus 1 (light beam scanning apparatus 2b) can expand the light scanning region in the first direction (x axis) is that a second angle θ_{yb} is different from a first angle θ_{ya} as illustrated in FIG. 9. As illustrated in FIG. 12, first angle θ_{ya} is an angle between the z axis and a first optical axis, which is projected on the first plane (zx plane), of light beam 12 that enters scanning mirror 20. That is, first angle θ_{ya} is an incident angle of light beam 12 to scanning mirror 20, light beam 12 being projected on the first plane (zx plane). Second angle θ_{yb} is an angle between the z axis and a second optical axis, which is projected on the first plane (zx plane), of light beam 12b that enters scanning mirror 20. That is, second angle θ_{yb} is an incident angle of light beam 12b to scanning mirror 20, light beam 12b being projected on the first plane (zx plane). In the present embodiment, second angle θ_{yb} is larger than first angle θ_{ya}.

As illustrated in FIG. 13, in the absence of light scanning region correcting optical member 50, the larger the angle between the z axis and the optical axis, which is projected on the first plane (zx plane), of each of the plurality of light beams 12, 12b that enter scanning mirror 20 is, the larger distortion of each of the plurality of light scanning regions 45, 46 formed by each of the plurality of light beams 12, 12b scanned by scanning mirror 20 is. That is, in the absence of light scanning region correcting optical member 50, the larger the incident angle to scanning mirror 20 of each of the plurality of light beams 12, 12b projected on the first plane (zx plane) is, the larger the distortion of each of the plurality of light scanning regions 45, 46 formed by each of the plurality of light beams 12, 12b scanned by scanning mirror 20 is.

Specifically, second angle θ_{yb} between the z axis and the second optical axis, which is projected on the first plane (zx plane), of light beam 12b that enters scanning mirror 20 is larger than first angle θ_{ya} between the z axis and the first optical axis, which is projected on the first plane (zx plane), of light beam 12 that enters scanning mirror 20. That is, the second incident angle of light beam 12b to scanning mirror 20, the light beam 12b being projected on the first plane (zx plane), is larger than the first incident angle of light beam 12 to scanning mirror 20, light beam 12 being projected on the first plane (zx plane). In the absence of light scanning region correcting optical member 50, the distortion of light scanning region 46 formed by light beam 12b scanned by scanning mirror 20 is larger than the distortion of light scanning region 45 formed by light beam 12 scanned by scanning mirror 20.

Light scanning region correcting optical member 50 is, for example, a lens having a free curved surface shape (see FIGS. 9 and 10) or a mirror having a free curved surface shape. Light scanning region correcting optical member 50 corrects at least one of the plurality of light scanning regions 45, 46 formed by the plurality of light beams 12, 12b scanned by scanning mirror 20. In particular, light scanning region correcting optical member 50 corrects all of the plurality of light scanning regions 45, 46 formed by the plurality of light beams 12, 12b scanned by scanning mirror 20.

Specifically, as the angle between the z axis and the optical axis, which is projected on the first plane (zx plane), of each of the plurality of light beams 12, 12b that enter scanning mirror 20 becomes larger, light scanning region correcting optical member 50 applies a larger negative power to each of the plurality of light beams 12, 12b. In this way, as the angle between the z axis and the optical axis, which is projected on the first plane (zx plane), of each of the plurality of light beams 12, 12b that enter the scanning mirror 20 is larger, light scanning region correcting optical member 50 more largely corrects the distortion of each of the plurality of light scanning regions 45, 46 corresponding to each of the plurality of light beams 12, 12b.

Specifically, light scanning region correcting optical member 50 applies a relatively weak negative power to light beam 12, but applies a relatively strong negative power to light beam 12b. Therefore, light scanning region correcting optical member 50 corrects the distortion of light scanning region 46 more largely than the distortion of light scanning region 45. A difference between a shape of light scanning region 45 and a shape of light scanning region 46 decreases. Each of the plurality of light scanning regions 45, 46 has a desired shape such as a substantially rectangular shape.

However, as each of the plurality of light beams 12, 12b receives a stronger negative power from light scanning region correcting optical member 50, each of the plurality of light beams 12, 12b spreads larger. As each of the plurality of light beams 12, 12b receives a stronger negative power from light scanning region correcting optical member 50, each of the plurality of light scanning regions 45, 46 corresponding to each of the plurality of light beams 12, 12b is irradiated with a lower light intensity per unit area, and a light intensity of each of the plurality of return lights 26, 26b corresponding to each of the plurality of light beams 12, 12b decreases. Therefore, as each of the plurality of light beams 12, 12b receives a stronger negative power from the light scanning region correcting optical member 50, a measurable distance or range of at least one object 9 using each of the plurality of light beams 12, 12b decreases. The measurable distance or range varies between the plurality of light scanning regions 45, 46.

Specifically, light scanning region correcting optical member 50 applies a relatively weak negative power to light beam 12, but applies a relatively strong negative power to light beam 12b. Therefore, light beam 12b spreads larger than light beam 12. The light intensity per unit area of light beam 12b with which at least one object 9 is irradiated is lower than the light intensity per unit area of light beam 12 with which the at least one object 9 is irradiated. The light intensity of return light 26b is lower than the light intensity of return light 26. The measurable distance or range of at least one object 9 using light beam 12b is smaller than the measurable distance or range of at least one object 9 using light beam 12. The measurable distance or range varies between the plurality of light scanning regions 45, 46.

In addition, as a stronger negative power is applied by light scanning region correcting optical member 50, each of the plurality of light beams 12, 12b spreads more largely and irradiates at least one object 9 with a wider area. Therefore, as each of the plurality of light beams 12, 12b receives a stronger negative power from light scanning region correcting optical member 50, the resolution of distance measurement apparatus 1 in each of the plurality of light scanning regions 45, 46 formed by each of the plurality of light beams 12, 12b decreases. The resolution of distance measurement apparatus 1 varies between the plurality of light scanning regions 45, 46.

Specifically, light scanning region correcting optical member 50 applies a relatively weak negative power to light beam 12, but applies a relatively strong negative power to light beam 12b. Therefore, light beam 12b spreads larger than light beam 12. An area of light beam 12b with which at least one object 9 is irradiated is larger than an area of light beam 12 with which at least one object 9 is irradiated. The resolution of distance measurement apparatus 1 in light scanning region 46 formed by light beam 12b is lower than the resolution of distance measurement apparatus 1 in light scanning region 45 formed by light beam 12.

Consequently, in the present embodiment, diameter D₂ of hole 32i of aperture 32b is made different from diameter D₁ of hole 32h of aperture 32 in accordance with the intensity of the negative power of each of the plurality of light beams 12, 12b received from light scanning region correcting optical member 50.

In one example of the present embodiment, as each of the plurality of light beams 12, 12b receives a stronger negative power from light scanning region correcting optical member 50, each of diameters D₁, D₂ of each of holes 32h, 32i of each of the plurality of apertures 32, 32b corresponding to each of the plurality of return lights 26, 26b corresponding to each of the plurality of light beams 12, 12b is made larger. Specifically, light beam 12b receives a stronger negative power from light scanning region correcting optical member 50 than light beam 12. Diameter D₂ of hole 32i of aperture 32b corresponding to return light 26b corresponding to light beam 12b is made larger than diameter D₁ of hole 32h of aperture 32 corresponding to return light 26 corresponding to light beam 12.

Therefore, each of the plurality of return lights 26, 26b corresponding to each of the plurality of light beams 12, 12b receiving a stronger negative power from the light scanning region correcting optical member 50 more reaches each of the plurality of light receiving elements 36, 36b corresponding to each of the plurality of return lights 26, 26b. Specifically, a light amount of return light 26b that passes through aperture 32b and reaches light receiving element 36b can be increased. The measurable distance and range of at least one object 9 using light beam 12b can be increased. Distance measurement apparatus 1 increases the measurable distance or range. In addition, the measurable distance or range of at least one object 9 using light beam 12b can be made close to or equal to the measurable distance or range of at least one object 9 using light beam 12. The variation in the measurable distance or range can be reduced between the plurality of light scanning regions 45, 46.

In another example of the present embodiment, as each of the plurality of light beams 12, 12b receives a stronger negative power from light scanning region correcting optical member 50, each of diameters D₁, D₂ of each of holes 32h, 32i of each of the plurality of apertures 32, 32b corresponding to each of the plurality of return lights 26, 26b corresponding to each of the plurality of light beams 12, 12b is made smaller. Specifically, light beam 12b receives a stronger negative power from light scanning region correcting optical member 50 than light beam 12. Diameter D₂ of hole 32i of aperture 32b is made smaller than diameter D₁ of hole 32h of aperture 32.

Therefore, as each of the plurality of light beams 12, 12b receives a stronger negative power from light scanning region correcting optical member 50, the angular range in which each of the plurality of return lights 26, 26b corresponding to each of the plurality of light beams 12, 12b can enter each of the plurality of light receiving elements 36, 36b corresponding to each of the plurality of return lights 26, 26b is smaller. Specifically, the angular range of return light 26b that can enter light receiving element 36b through aperture 32b is smaller than the angular range of return light 26 that can enter light receiving element 36 through aperture 32. The resolution of distance measurement apparatus 1 in light scanning region 46 formed by light beam 12b can be improved. In addition, the resolution of distance measurement apparatus 1 in light scanning region 46 formed by light beam 12b can be made close to or equal to the resolution of distance measurement apparatus 1 in light scanning region 45 formed by light beam 12. The variation in the resolution of distance measurement apparatus 1 can be reduced between the plurality of light scanning regions 45, 46.

The plurality of light sources 10, 10b are disposed on one side (+y direction side) with respect to the first plane (zx plane). As the angle between the z axis and the optical axis, which is projected on the first plane (zx plane), of each of the plurality of light beams 12, 12b that enter scanning mirror 20 becomes larger, the angle between the z axis and the optical axis, which is projected on the second plane (yz plane), of each of the plurality of light beams 12, 12b that enter scanning mirror 20 becomes larger. That is, as the incident angle of each of the plurality of light beams 12, 12b to scanning mirror 20, the light beams 12, 12b being projected on the first plane (zx plane), is larger, the incident angle of each of the plurality of light beams 12, 12b to scanning mirror 20, the plurality of light beams 12, 12b being projected on the second plane (yz plane), is larger. Therefore, shift between the plurality of light scanning regions 45, 46 in the y-axis direction perpendicular to the x axis and the z axis is reduced. Continuity of the plurality of light scanning regions 45, 46 is improved.

Specifically, second angle θ_{yb} between the z axis and the second optical axis, which is projected on the first plane (zx plane), of light beam 12b that enters scanning mirror 20 is larger than first angle θ_{ya} between the z axis and the first optical axis, which is projected on the first plane (zx plane), of light beam 12 that enters scanning mirror 20. That is, the incident angle of light beam 12b to scanning mirror 20, the light beam 12b being projected on the first plane (zx plane), is larger than the incident angle of light beam 12 to scanning mirror 20, light beam 12 being projected on the first plane (zx plane). A fourth angle θ_{xb} between the z axis and the second optical axis, which is projected on the second plane (yz plane), of light beam 12b that enters scanning mirror 20 is larger than a third angle θₓₐ (see FIG. 12) between the z axis and the first optical axis, which is projected on the second plane (yz plane), of light beam 12 that enters scanning mirror 20. That is, the incident angle of light beam 12b to scanning mirror 20, the light beam 12b being projected on the second plane (yz plane), is larger than the incident angle of light beam 12 to scanning mirror 20, light beam 12 being projected on the second plane (yz plane).

Referring to FIG. 1, controller 4 is further communicably connected to light source 10b and light receiving element 36b. Controller 4 controls light sources 10, 10b to control timing when pulsed light beam 12b is emitted from the light sources 10, 10b. Controller 4 receives, from light sources 10, 10b, first timing when light sources 10, 10b emit light beams 12, 12b. Controller 4 receives, from light receiving elements 36, 36b, signals corresponding to light amounts of return lights 26, 26b received by light receiving elements 36, 36b. Controller 4 receives second timing when light receiving elements 36, 36b receive return lights 26, 26b.

Calculator 5 calculates emission directions of light beams 12, 12b from the tilting angle of scanning mirror 20 received by controller 4 and positions of light sources 10, 10b with respect to scanning mirror 20 stored in storage device 6. Calculator 5 receives, from controller 4, the first timing when light sources 10, 10b emit light beams 12, 12b. Calculator 5 receives, from controller 4, the second timing when light receiving elements 36, 36b receive return lights 26, 26b. Calculator 5 calculates the distance from distance measurement apparatus 1 to at least one object 9 and the direction of at least one object 9 with respect to distance measurement apparatus 1 on the basis of the emission directions of light beams 12, 12b, the first timing when light sources 10, 10b emit light beams 12, 12b, and the second timing when light receiving elements 36, 36b receive return lights 26, 26b. Similarly to the first embodiment, calculator 5 generates a distance image of at least one object 9. Similarly to the first embodiment, calculator 5 outputs the distance image of at least one object 9 to the display device (not illustrated).

In a first modification of the present embodiment, similarly to the first modification of the first embodiment (see FIG. 5), optical diffusion element 33 or the diffractive optical element is disposed between aperture 32 and light receiving element 36, and optical diffusion element 33 or the diffractive optical element is disposed between aperture 32b and light receiving element 36b.

In a second modification of the present embodiment, similarly to the second embodiment (see FIG. 7), rear aperture 34 is disposed between aperture 32 and light receiving element 36, and a second rear aperture is disposed between aperture 32b and light receiving element 36b.

In a third modification of the present embodiment, a number of the plurality of light sources 10, 10b is three or more.

Distance measurement apparatus 1 of the present embodiment has the following effects in addition to the effects of distance measurement apparatus 1 of the first embodiment.

Distance measurement apparatus 1 of the present embodiment further includes light scanning region correcting optical member 50. Light scanning region correcting optical member 50 corrects a first light scanning region (light scanning region 45) formed by the first light beam (light beam 12) scanned by scanning mirror 20.

Therefore, even if the first light beam (light beam 12) is expanded by light scanning region correcting optical member 50, the first aperture (aperture 32) limits the angular range of the first return light (return light 26) that can enter the first light receiving element (light receiving element 36). Therefore, light scanning region 45 can be more desirably shaped by using light scanning region correcting optical member 50, and the resolution of distance measurement apparatus 1 can be improved.

Distance measurement apparatus 1 of the present embodiment further includes a second light source (light source 10b) and a second light receiving optical system (light receiving optical system 30b). The second light source emits a second light beam (light beam 12b). The second light receiving optical system receives a second return light (return light 26b) generated by the second light beam being reflected or scattered by at least one object 9. Scanning mirror 20 further scans the second light beam. Light scanning region correcting optical member 50 further corrects a second light scanning region (light scanning region 46) formed by the second light beam scanned by scanning mirror 20. The second light receiving optical system includes a second focusing optical system (focusing optical system 31b), a second light receiving element (light receiving element 36b), and a second aperture (aperture 32b) located between the second focusing optical system and the second light receiving element. The second aperture is disposed on a second focal plane of the second focusing optical system. Second viewing angle θ₂ of the second light receiving optical system is smaller than the second divergence angle of the second light beam. Second viewing angle θ₂ is given by arctan (D₂/f₂). f₂ represents a second focal distance of the second focusing optical system, and D₂ represents a second diameter (diameter D₂) of a second hole (hole 32i) provided in the second aperture. The second diameter of the second hole of the second aperture is different from the first diameter (diameter D₁) of the first hole (hole 32h) of the first aperture (aperture 32).

Therefore, even if the second light beam (light beam 12b) is expanded by light scanning region correcting optical member 50, the second aperture (aperture 32b) limits the angular range of the second return light (return light 26b) that can enter the second light receiving element (light receiving element 36b). Therefore, the resolution of distance measurement apparatus 1 can be improved.

In addition, the second diameter (diameter D₂) of the second hole (hole 32i) of the second aperture (aperture 32b) is different from the first diameter (diameter D₁) of the first hole (hole 32h) of the first aperture (aperture 32). Therefore, it is possible to reduce variation in distance or range that can be measured by distance measurement apparatus 1 or variation in resolution of distance measurement apparatus 1 over the entire first light scanning region (light scanning region 45) and second light scanning region (light scanning region 46).

In distance measurement apparatus 1 of the present embodiment, a direction in which the light scanning region of distance measurement apparatus 1 is expanded by a first end portion of the first light scanning region (light scanning region 45) overlapping only a second end portion of the second light scanning region (light scanning region 46) or being in contact with the second end portion of the second light scanning region is defined as a first axis (x axis). Normal line 23 of scanning mirror 20 when scanning mirror 20 is at the center of the rotation range of scanning mirror 20 corresponding to the first light scanning region and the second light scanning region is defined as a second axis (z axis). The second angle between the second axis and the second optical axis, which is projected on a plane including the first axis and the second axis (zx plane), of the second light beam (light beam 12b) that enters scanning mirror 20 is larger than the first angle between the second axis and the first optical axis, which is projected on the above plane (zx plane), of the first light beam (light beam 12) that enters scanning mirror 20. The second diameter (diameter D₂) of the second hole (hole 32i) of the second aperture (aperture 32b) is larger than the first diameter (diameter D₁) of the first hole (hole 32h) of the first aperture (aperture 32).

Therefore, a light amount of the second return light (return light 26b) passing through the second aperture (aperture 32b) can be increased. The measurable distance and range of at least one object 9 using the second light beam (light beam 12b) can be increased. Distance measurement apparatus 1 increases the measurable distance or range. In addition, the measurable distance or range of at least one object 9 using the second light beam (light beam 12b) can be made close to or equal to the measurable distance or range of at least one object 9 using the first light beam (light beam 12). The variation in the measurable distance or range can be reduced between the first light scanning region (light scanning region 45) and the second light scanning region (light scanning region 46).

Distance measurement apparatus 1 of the present embodiment includes the plurality of light sources 10, 10b, scanning mirror 20, light scanning region correcting optical member 50, and the plurality of light receiving optical systems 30, 30b. The plurality of light sources 10, 10b emit the plurality of light beams 12, 12b, respectively. Scanning mirror 20 scans the plurality of light beams 12, 12b. Light scanning region correcting optical member 50 corrects at least one of the plurality of light scanning regions 45, 46 formed by the plurality of light beams 12, 12b scanned by scanning mirror 20. The plurality of light receiving optical systems 30, 30b respectively receive the plurality of return lights 26, 26b generated by the plurality of light beams 12, 12b being reflected or scattered by at least one object 9. The plurality of light receiving optical systems 30, 30b include focusing optical systems 31, 31b, light receiving elements 36, 36b, and apertures 32, 32b located between focusing optical systems 31, 31b and light receiving elements 36, 36b, respectively. Apertures 32, 32b are disposed on the focal planes of focusing optical systems 31, 31b, respectively. The viewing angles of light receiving optical systems 30, 30b are smaller than the divergence angles of the plurality of light beams 12, 12b corresponding to light receiving optical systems 30, 30b, respectively. The viewing angles of light receiving optical systems 30, 30b are given by arctan (D/f). f represents the focal distances of focusing optical systems 31, 31b. D represents the diameters of holes 32h, 32i provided in apertures 32, 32b.

The direction in which the light scanning region is expanded by the first end portion of one of the pair of light scanning regions adjacent to each other among the plurality of light scanning regions 45, 46 overlapping only the second end portion of another one of the pair of light scanning regions or being in contact with the second end portion of the other one of the pair of light scanning regions is defined as the first axis (x axis). Normal line 23 of scanning mirror 20 when scanning mirror 20 is at the center of the rotation range of scanning mirror 20 corresponding to the plurality of light scanning regions 45, 46 is defined as the second axis (z axis). As the angle between the second axis (z axis) and the optical axis, which is projected on the plane (zx plane) including the first axis (x axis) and the second axis (z axis), of each of the plurality of light beams 12, 12b that enter the scanning mirror 20 is larger, the diameters of the holes 32h, 32i provided in apertures 32, 32b corresponding to the plurality of light beams 12, 12b, respectively are larger.

Therefore, distance measurement apparatus 1 increases the measurable distance or range. The variation in the measurable distance or range can be reduced between the plurality of light scanning regions 45, 46.

In distance measurement apparatus 1 of the present embodiment, the direction in which the light scanning region of distance measurement apparatus 1 is expanded by the first end portion of the first light scanning region (light scanning region 45) overlapping only the second end portion of the second light scanning region (light scanning region 46) or being in contact with the second end portion of the second light scanning region is defined as the first axis (x axis). Normal line 23 of scanning mirror 20 when scanning mirror 20 is at the center of the rotation range of scanning mirror 20 corresponding to the first light scanning region and the second light scanning region is defined as the second axis (z axis). The second angle between the second axis and the second optical axis, which is projected on a plane including the first axis and the second axis (zx plane), of the second light beam (light beam 12b) that enters scanning mirror 20 is larger than the first angle between the second axis and the first optical axis, which is projected on the above plane (zx plane), of the first light beam (light beam 12) that enters scanning mirror 20. The second diameter (diameter D₂) of the second hole (hole 32i) of the second aperture (aperture 32b) is smaller than the first diameter (diameter D₁) of the first hole (hole 32h) of the first aperture (aperture 32).

Therefore, the resolution of distance measurement apparatus 1 in the second light scanning region (light scanning region 46) formed by the second light beam (light beam 12b) can be improved. In addition, the resolution of distance measurement apparatus 1 in the second light scanning region (light scanning region 46) formed by the second light beam (light beam 12b) can be made close to or equal to the resolution of distance measurement apparatus 1 in the first light scanning region (light scanning region 45) formed by the first light beam (light beam 12). The variation in the resolution of distance measurement apparatus 1 can be reduced between the first light scanning region (light scanning region 45) and the second light scanning region (light scanning region 46).

Distance measurement apparatus 1 of the present embodiment includes the plurality of light sources 10, 10b, scanning mirror 20, light scanning region correcting optical member 50, and the plurality of light receiving optical systems 30, 30b. The plurality of light sources 10, 10b emit the plurality of light beams 12, 12b, respectively. Scanning mirror 20 scans the plurality of light beams 12, 12b. Light scanning region correcting optical member 50 corrects at least one of the plurality of light scanning regions 45, 46 formed by the plurality of light beams 12, 12b scanned by scanning mirror 20. The plurality of light receiving optical systems 30, 30b respectively receive the plurality of return lights 26, 26b generated by the plurality of light beams 12, 12b being reflected or scattered by at least one object 9. The plurality of light receiving optical systems 30, 30b include focusing optical systems 31, 31b, light receiving elements 36, 36b, and apertures 32, 32b located between focusing optical systems 31, 31b and light receiving elements 36, 36b, respectively. Apertures 32, 32b are disposed on the focal planes of focusing optical systems 31, 31b, respectively. The viewing angles of light receiving optical systems 30, 30b are smaller than the divergence angles of the plurality of light beams 12, 12b corresponding to light receiving optical systems 30, 30b, respectively. The viewing angles of light receiving optical systems 30, 30b are given by arctan (D/f). f represents the focal distances of focusing optical systems 31, 31b. D represents the diameters of holes 32h, 32i provided in apertures 32, 32b.

The direction in which the light scanning region is expanded by the first end portion of one of the pair of light scanning regions adjacent to each other among the plurality of light scanning regions 45, 46 overlapping only the second end portion of the other one of the pair of light scanning regions or being in contact with the second end portion of the other one of the pair of light scanning regions is defined as the first axis (x axis). Normal line 23 of scanning mirror 20 when scanning mirror 20 is at the center of the rotation range of scanning mirror 20 corresponding to the plurality of light scanning regions 45, 46 is defined as the second axis (z axis). As the angle between the second axis (z axis) and the optical axis, which is projected on the plane (zx plane) including the first axis (x axis) and the second axis (z axis), of each of the plurality of light beams 12, 12b that enter the scanning mirror 20 is larger, the diameters of the holes 32h, 32i provided in apertures 32, 32b corresponding to the plurality of light beams 12, 12b, respectively are smaller.

Therefore, the measurable distance or range with the improved resolution is increased. The variation in the resolution of distance measurement apparatus 1 can be reduced between the plurality of light scanning regions 45, 46.

It should be considered that the first to third embodiments and the modifications thereof disclosed this time are illustrative in all respects, and are not restrictive. As long as there is no contradiction, at least two of the first to third embodiments and the modifications thereof may be combined. For example, the scope of the present invention is defined not by the description above but by the claims, and it is intended that all modifications within meaning and scope equivalent to the claims are included.

### REFERENCE SIGNS LIST

1: distance measurement apparatus, 2, 2a, 2b: light beam scanning apparatus, 3: computer, 4: controller, 5: calculator, 6: storage device, 7: housing, 8: transparent window, 9: object, 10, 10b: light source, 11a, 11b, 11c: light emission point, 12, 12b: light beam, 13a, 13b, 13c: light beam, 15, 15b: irradiation optical system, 15p: optical axis, 16, 16b: optical beam splitter, 17: reflective portion, 18: transmissive portion, 20: scanning mirror, 21, 22: rotation axis, 23: normal line, 26, 26b: return light, 30, 30a, 30b: light receiving optical system, 31, 31b: focusing optical system, 32, 32b: aperture, 32h, 32i: hole, 33: optical diffusion element, 34: rear aperture, 34h: hole, 36, 36b: light receiving element, 37, 37b: light receiving region, 41, 42: stray light, 45, 46: light scanning region, 50: light scanning region correcting optical member

1. A distance measurement apparatus comprising:
a first light source to emit a first light beam;
a scanning mirror to scan the first light beam; and
a first light receiving optical system to receive a first return light generated by the first light beam being reflected or scattered by at least one object,
wherein the first light receiving optical system includes a first focusing optical system, a first light receiving element, and a first aperture located between the first focusing optical system and the first light receiving element,
the first aperture is disposed on a first focal plane of the first focusing optical system,
a first viewing angle of the first light receiving optical system is smaller than a first divergence angle of the first light beam,
the first viewing angle is given by arctan (D₁/f₁), and
f₁ represents a first focal distance of the first focusing optical system, and D₁ represents a first diameter of a first hole provided in the first aperture.

2. The distance measurement apparatus according to claim 1,
wherein a viewing angle of the first light receiving optical system without the first aperture is larger than the first divergence angle of the first light beam,
the viewing angle of the first light receiving optical system is given by arctan (Dᵣ₁/d₁), and
d₁ represents a distance between the first focusing optical system and a light receiving region of the first light receiving element, and Dᵣ₁ represents a diameter of the light receiving region.

3. The distance measurement apparatus according to claim 1, wherein the first light source is a laser including a plurality of light emission points arranged or a multi-mode laser.

4. The distance measurement apparatus according to claim 1, wherein the first light receiving optical system further includes an optical diffusion element or a diffractive optical element disposed between the first aperture and the first light receiving element.

5. The distance measurement apparatus according to claim 1,
wherein the first light receiving optical system further includes a rear aperture disposed between the first aperture and the first light receiving element, and
a diameter of a hole of the rear aperture is larger than the first diameter.

6. The distance measurement apparatus according to claim 1, further comprising a light scanning region correcting optical member,
wherein the light scanning region correcting optical member corrects a first light scanning region formed by the first light beam scanned by the scanning mirror.

7. The distance measurement apparatus according to claim 6, further comprising:
a second light source to emit a second light beam; and
a second light receiving optical system to receive a second return light generated by the second light beam being reflected or scattered by the at least one object,
wherein the scanning mirror further scans the second light beam,
the light scanning region correcting optical member further corrects a second light scanning region formed by the second light beam scanned by the scanning mirror,
the second light receiving optical system includes a second focusing optical system, a second light receiving element, and a second aperture located between the second focusing optical system and the second light receiving element,
the second aperture is disposed on a second focal plane of the second focusing optical system,
a second viewing angle of the second light receiving optical system is smaller than a second divergence angle of the second light beam,
the second viewing angle is given by arctan (D₂/f₂),
f₂ represents a second focal distance of the second focusing optical system, and D₂ represents a second diameter of a second hole provided in the second aperture, and
the second diameter is different from the first diameter.

8. The distance measurement apparatus according to claim 7,
wherein a direction in which a light scanning region of the distance measurement apparatus is expanded by a first end portion of the first light scanning region overlapping only a second end portion of the second light scanning region or being in contact with the second end portion of the second light scanning region is defined as a first axis,
a normal line of the scanning mirror when the scanning mirror is at a center of a rotation range of the scanning mirror corresponding to the first light scanning region and the second light scanning region is defined as a second axis,
a second angle between the second axis and a second optical axis, which is projected on a plane including the first axis and the second axis, of the second light beam to enter the scanning mirror is larger than a first angle between the second axis and a first optical axis, which is projected on the plane, of the first light beam to enter the scanning mirror, and
the second diameter is larger than the first diameter.

9. The distance measurement apparatus according to claim 7,
wherein a direction in which a light scanning region of the distance measurement apparatus is expanded by a first end portion of the first light scanning region overlapping only a second end portion of the second light scanning region or being in contact with the second end portion of the second light scanning region is defined as a first axis,
a normal line of the scanning mirror when the scanning mirror is at a center of a rotation range of the scanning mirror corresponding to the first light scanning region and the second light scanning region is defined as a second axis,
a second angle between the second axis and a second optical axis, which is projected on a plane including the first axis and the second axis, of the second light beam to enter the scanning mirror is larger than a first angle between the second axis and a first optical axis, which is projected on the plane, of the first light beam to enter the scanning mirror, and
the second diameter is smaller than the first diameter.

10. A distance measurement apparatus comprising:
a plurality of light sources to respectively emit a plurality of light beams;
a scanning mirror to scan the plurality of light beams;
a light scanning region correcting optical member to correct at least one of a plurality of light scanning regions formed by the plurality of light beams scanned by the scanning mirror; and
a plurality of light receiving optical systems to respectively receive a plurality of return lights generated by the plurality of light beams being reflected or scattered by at least one object,
each of the plurality of light receiving optical systems includes a focusing optical system, a light receiving element, and an aperture located between the focusing optical system and the light receiving element,
the aperture is disposed on a focal plane of the focusing optical system,
a viewing angle of the light receiving optical system is smaller than a divergence angle of each of the plurality of light beams corresponding to the light receiving optical systems,
the viewing angle is given by arctan (D/f),
f represents a focal distance of the focusing optical system, and D represents a diameter of a hole provided in the aperture,
a direction in which a light scanning region is expanded by a first end portion of one of a pair of light scanning regions adjacent to each other among the plurality of light scanning regions overlapping only a second end portion of another one of the pair of light scanning regions or being in contact with the second end portion of the other one of the pair of light scanning regions is defined as a first axis,
a normal line of the scanning mirror when the scanning mirror is at a center of a rotation range of the scanning mirror corresponding to the plurality of light scanning regions is defined as a second axis, and
as an angle between the second axis and an optical axis, which is projected on a plane including the first axis and the second axis, of each of the plurality of light beams to enter the scanning mirror is larger, the diameter of the hole provided in the aperture corresponding to each of the plurality of light beams is larger.

11. A distance measurement apparatus comprising:
a plurality of light sources to respectively emit a plurality of light beams;
a scanning mirror to scan the plurality of light beams;
a light scanning region correcting optical member to correct at least one of a plurality of light scanning regions formed by the plurality of light beams scanned by the scanning mirror; and
a plurality of light receiving optical systems to respectively receive a plurality of return lights generated by the plurality of light beams being reflected or scattered by at least one object,
each of the plurality of light receiving optical systems includes a focusing optical system, a light receiving element, and an aperture located between the focusing optical system and the light receiving element,
the aperture is disposed on a focal plane of the focusing optical system,
a viewing angle of the light receiving optical system is smaller than a divergence angle of each of the plurality of light beams corresponding to the light receiving optical systems,
the viewing angle is given by arctan (D/f),
f represents a focal distance of the focusing optical system, and D represents a diameter of a hole provided in the aperture,
a direction in which a light scanning region is expanded by a first end portion of one of a pair of light scanning regions adjacent to each other among the plurality of light scanning regions overlapping only a second end portion of another one of the pair of light scanning regions or being in contact with the second end portion of the other one of the pair of light scanning regions is defined as a first axis,
a normal line of the scanning mirror when the scanning mirror is at a center of a rotation range of the scanning mirror corresponding to the plurality of light scanning regions is defined as a second axis, and
as an angle between the second axis and an optical axis, which is projected on a plane including the first axis and the second axis, of each of the plurality of light beams to enter the scanning mirror is larger, the diameter of the hole provided in the aperture corresponding to each of the plurality of light beams is smaller.
